(19) United States
(12) Patent Application Publication
(10) Pub. No.: US 2022/0162013 A1
(43) Pub. Date: May 26, 2022

(54) METHOD FOR PROVIDING INFORMATION AND ELECTRONIC DEVICE PERFORMING THE SAME

(71) Applicant: Coupang Corp., Seoul (KR)

(72) Inventor: Jung Woo Cheon, Seoul (KR)

(21) Appl. No.: 17/136,639

(22) Filed: Dec. 29, 2020

(30) Foreign Application Priority Data
Nov. 20, 2020 (KR) 10-2020-0156714

(51) Int. Cl. B65G 43/08; B65G 1/137; B65G 47/46

(52) U.S. Cl. CPC B65G 43/08; B65G 1/1373; B65G 47/46; B65G 2203/0216; B65G 2209/04; B65G 2203/041; B65G 2203/025; B65G 2203/042

(57) ABSTRACT

According to various example embodiments, information providing method of an electronic device may include identifying delivery-related information regarding a load moving along a moving path of the load past at least one sensor, identifying a task position at which the load is to be picked up from among a plurality of task areas along the moving path based on the delivery-related information, estimating a point in time at which the load approaches the task position, and providing information related to an approach of the load to the task position based on the estimated point in time. In addition, other various embodiments are possible.

### BACKGROUND

### Technical Field

Example embodiments of the present disclosure relate to a method of providing information and an electronic device performing the same and, more particularly, to a method and apparatus for providing information associated with access to a task position of a load.

### Description of the Related Art

As the use of the Internet becomes familiar, the e-commerce market is expanding. Due to the expanding trend of the e-commerce market, the demand for the industry related to the delivery of items (loads) is also increasing rapidly. These delivery-related services may be performed through several steps such as packaging, warehousing, picking, loading, transport, unloading, delivery, and storage of goods. In such process, a conveyor belt may be used to facilitate the transport of the items. For example, a plurality of loads is transported in one direction through a conveyor belt, and may have to be properly classified according to the characteristics of each load while being transported.

Typically, a load pickup task has been performed in the way that each worker individually identifies the load characteristic information through barcode recognition in the process of sorting the loads according to characteristics of the loads by several workers. In this process, each worker may pick up the load if it is the load to be picked up. However, if the task is performed in this way, the next worker may have to repeat the identification process again even though another worker has already completed the process of identifying the characteristic information of or regarding the load, which is not efficient. In particular, since the worker placed at the front end of the conveyor belt may have to perform the identification of characteristic information for all loads, considerable fatigue may accumulate in the working process.

### SUMMARY

### Technical Goals

To solve the above issues, the present disclosure is to provide a load-related information providing method and device enabling effective load classification by automatically identifying load characteristic information using at least one sensor and providing load-related information to each task operator based on the identified load characteristic information.

### Technical Solutions

According to an aspect, there is provided an information providing method of an electronic device, the method including identifying delivery-related information of a load moving on or along a moving path of the load through or past at least one sensor, identifying a task position at which the load is to be picked up among a plurality of task areas on the moving path based on the delivery-related information, estimating a point in time at which the load accesses or approaches the task position, and providing information related to an access of the load at the task position based on the estimated point in time.

According to another aspect, there is also provided an electronic device including a processor, a memory electrically connected to the processor, an output module, and at least one sensor, wherein the processor is set to identify delivery-related information of a load moving on a moving path of the load using the at least one sensor, identify a task position at which the load is to be picked up among a plurality of task areas on the moving path based on the delivery-related information, estimate a point in time at which the load accesses the task position, and output information related to an access of the load at the task position based on the estimated point in time using an output module.

### Effects

According to example embodiments of the present disclosure, an electronic device may automatically analyze characteristic information of loads in a process of classifying the loads and provide relevant information to a task area in which the corresponding load is to be handled, thereby enabling an efficient classification task and minimizing operator's fatigue.

### BRIEF DESCRIPTION OF THE DRAWINGS

FIG. 1 is a block diagram illustrating an electronic device according to various example embodiments of the present disclosure.

FIG. 2 is a diagram illustrating a setting input screen for providing load-related information according to an example embodiment of the present disclosure.

FIGS. 3A and 3B are diagrams illustrating a method of providing load-related information in an electronic device according to an example embodiment of the present disclosure.

FIGS. 4A through 4C are diagrams illustrating a method of providing load-related information in an electronic device according to various example embodiments of the present disclosure.

FIGS. 5A through 5C are diagrams illustrating an operation scheme of an output module according to an example embodiment of the present disclosure.

FIG. 6 is a diagram illustrating an operation of a sensor of an electronic device according to an example embodiment of the present disclosure.

### DETAILED DESCRIPTION

The terms used in the embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

The expression “at least one of A, B, and C” may include the following meanings: A alone; B alone; C alone; both A and B together; both A and C together; both B and C together; and all three of A, B, and C together.

In the following description, embodiments of the present disclosure will be described in detail with reference to the drawings so that those skilled in the art can easily carry out the present disclosure. The present disclosure may be embodied in many different forms and is not limited to the embodiments described herein.

Hereinafter, example embodiments of the present disclosure will be described in detail with reference to the accompanying drawings.

In describing the embodiments, descriptions of technical contents that are well known in the art to which the present disclosure belongs and are not directly related to the present specification will be omitted. This is to more clearly communicate without obscure the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the present disclosure and methods of achieving them will be apparent from the following exemplary embodiments that will be described in more detail with reference to the accompanying drawings. It should be noted, however, that the present disclosure is not limited to the following exemplary embodiments, and may be implemented in various forms. Accordingly, the exemplary embodiments are provided only to disclose the present disclosure and let those skilled in the art know the category of the present disclosure. In the drawings, embodiments of the present disclosure are not limited to the specific examples provided herein and are exaggerated for clarity. The same reference numerals or the same reference designators denote the same elements throughout the specification.

At this point, it will be understood that each block of the flowchart illustrations and combinations of flowchart illustrations may be performed by computer program instructions. Since these computer program instructions may be mounted on a processor of a general purpose computer, special purpose computer, or other programmable data processing equipment, those instructions executed through the computer or the processor of other programmable data processing equipment may create a means to perform the functions be described in flowchart block(s). These computer program instructions may be stored in a computer usable or computer readable memory that can be directed to a computer or other programmable data processing equipment to implement functionality in a particular manner, and thus the computer usable or computer readable memory. It is also possible for the instructions stored in to produce an article of manufacture containing instruction means for performing the functions described in the flowchart block(s). Computer program instructions may also be mounted on a computer or other programmable data processing equipment, such that a series of operating steps may be performed on the computer or other programmable data processing equipment to create a computer-implemented process to create a computer or other programmable data. Instructions for performing the processing equipment may also provide steps for performing the functions described in the flowchart block(s).

In addition, each block may represent a portion of a module, segment, or code that includes one or more executable instructions for executing a specified logical function(s). It should also be noted that in some alternative implementations, the functions noted in the blocks may occur out of order. For example, the two blocks shown in succession may in fact be executed substantially concurrently, or the blocks may sometimes be executed in the reverse order, depending on the corresponding function.

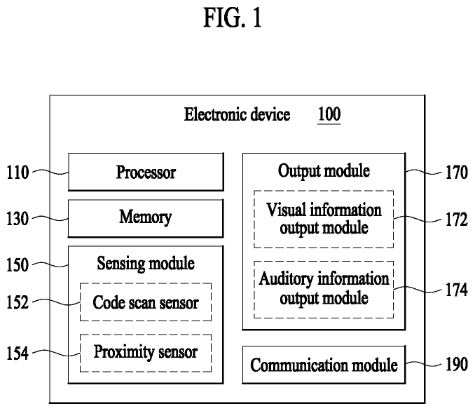

FIG. 1 is a block diagram illustrating an electronic device according to various example embodiments of the present disclosure.

According to various example embodiments, an electronic device 100 may correspond to a device for providing information on a task area (or task position) in which a predetermined task is to be performed in association with a load transported on a load moving path (e.g., a load transport path of a conveyor belt).

Referring to FIG. 1, the electronic device 100 according to various example embodiments may include at least a portion of a processor 110, a memory 130, a sensing module 150 including at least one sensor, an output module 170, and a communication module 190.

The processor 110 may process a series of operations for performing a method of providing information related to a task of a load according to various example embodiments of the present disclosure. To this end, the processor 110 may control components included in the electronic device 100 overall.

The processor 110 may acquire information related to a current transport location of a load and/or information related to delivery of a load based on predetermined sensing information acquired through the sensing module 150. For example, the processor 110 may use delivery-related information (e.g., delivery destination-related information) of a load to determine a task position at which a pickup task of the load is to be performed. Also, the processor 110 may accurately estimate a predicted access time point of the load for a task position at which the pickup task of the load is to be performed based on the current transport location of the load, a load transport speed of a conveyor belt, and sensing information of a sensor.

The processor 110 may control the output module 170 to output predetermined information to the task position at a predicted point in time that the load accesses the task position. For example, the processor 110 may control the output module 170 to output at least one of visual information or auditory information to the task position.

In addition, the processor 110 may provide a control command to the output module 170 to determine whether light is output from a light output device included in the output module 170 (e.g., a visual information output module 172) according to an example embodiment, adjust a frequency band of light to be output, or control a position or angle of a reflector.

The memory 130 may be electrically connected to the processor 110 and store various instructions related to an operation of the processor 110. In addition, the memory 130 may store data (or information) related to various functions provided by the electronic device 100.

As an example, the memory 130 may store at least a portion of position information (or distance information) related to a plurality of task areas on a moving path (e.g., conveyor belt) of a load, load transport speed information (for example, load transport speed information of the conveyor belt), or delivery-related information (for example, delivery destination information) of a load corresponding to each task area.

The sensing module 150 may include at least one sensor (e.g., a code scan sensor 152, a proximity sensor 154) and sense various information related to the load. For example, the code scan sensor 152 may scan code information (e.g., barcode, quick response (QR) code, text data, recognition pattern, radio-frequency identification (RFID) tag, etc.) attached external to the load and acquire information related to delivery of the load based on the code information. The code scan sensor 152 may include at least one of, for example, an infrared (IR) sensor, an image sensor, or a near-field communication (NFC) module. For example, the proximity sensor 154 (or a pressure sensor or a temperature sensor) may identify an object (e.g., a load) approaching within a predetermined distance from a position of the proximity sensor 154. In an example embodiment, the sensing module 150 may also be implemented through a camera or, for example, acquire information related to delivery of the load by acquiring image information and processing the acquired image information.

The output module 170 may include the visual information output module 172 that provides visual information to a position corresponding to a predetermined task area of the load and/or an auditory information output module 174 that provides auditory information.

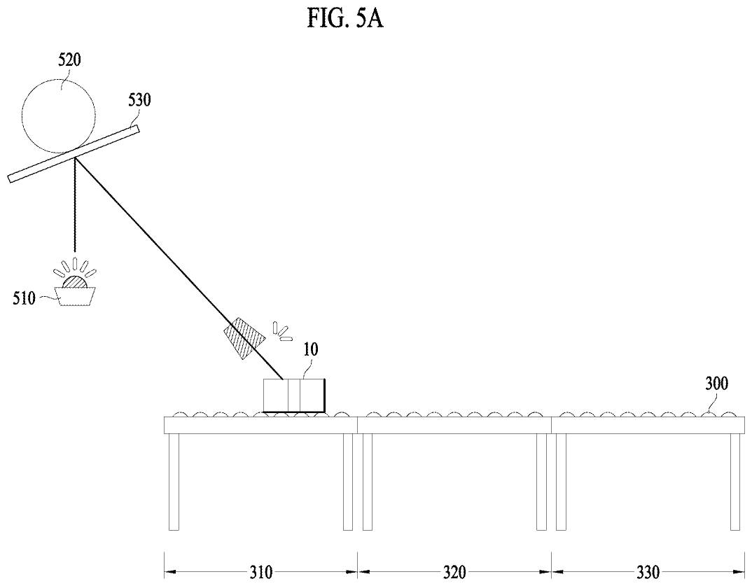

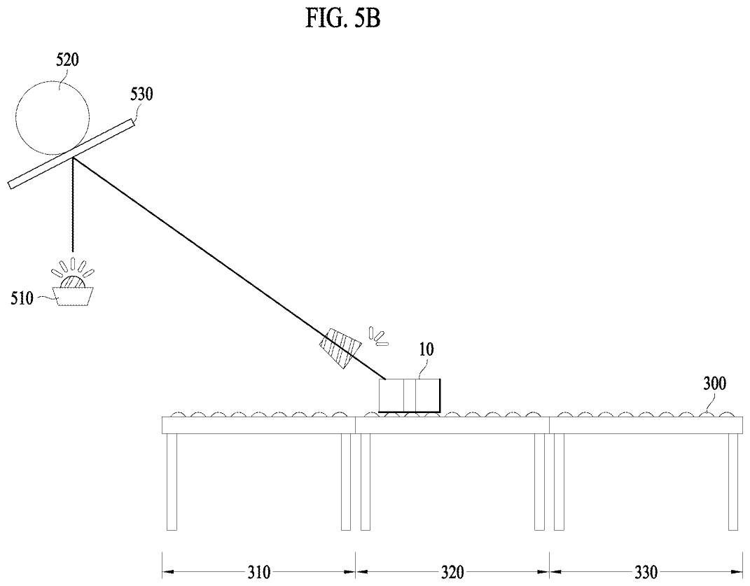

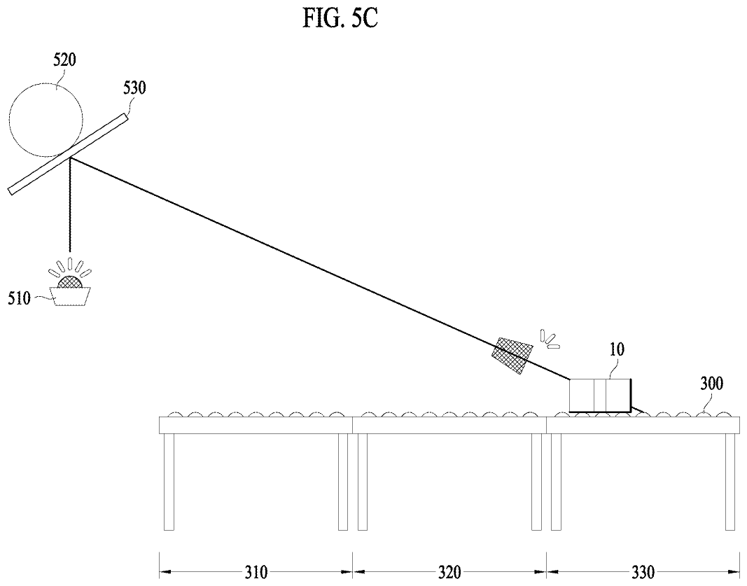

According to various example embodiments, the visual information output module 172 may be provided individually in an upper portion or a side portion of the plurality of task areas, or implemented using a reflector and a driving module to output visual information to the plurality of task areas using a single light output device. A related description will be given in greater detail with reference to FIGS. 5A through 5C.

The visual information output module 172 may include various types of lightings (e.g., a slit lighting) or lamps, and configured to selectively output visual information of various frequency bands (that is, various colors) corresponding to an information providing method of the electronic device 100 based on whether the load accesses. For example, the visual information output module 172 may output visual information in accordance with a predetermined load approaching and terminate outputting the visual information in response to the load being picked up or being away in a predetermined distance or farther in accordance with the conveyor belt being driven. Also, the visual information output module 172 may output visual information with different colors based on a task area of each load.

Meanwhile, the output module 170 according to an example embodiment may be physically spaced apart from other components of the electronic device 100, and may transmit or receive information regarding whether to provide the information to or from the processor 110 of the electronic device 100 through the communication module 190 based on wired or wireless communication.

The communication module 190 may perform a function of transmitting information stored in the memory 130 of the electronic device 100 or predetermined information processed by the processor 110 to another device, or receiving predetermined information into the electronic device 100 from another device. For example, the electronic device 100 may be implemented as a device separate from at least a portion of the aforementioned sensing module 150 or output module 170, and may function as an integral device in a manner of transmitting and receiving information through the communication module 190. Also, the communication module 190 may receive, from an external device, at least a portion of information related to a load transport speed of a conveyor belt, quantity information of a plurality of task areas on the conveyor belt, respective position information, and load destination information corresponding to the task areas. According to various example embodiments, the communication module 190 may include a transceiver to transmit and receive information. The communication module 190 may include at least one of, for example, Bluetooth™, BLE, Wireless Fidelity (Wi-Fi), Zigbee, Ethernet, RF, LoRa, Powerline communication, RS485, CAN communication, USB, and TCP/IP.

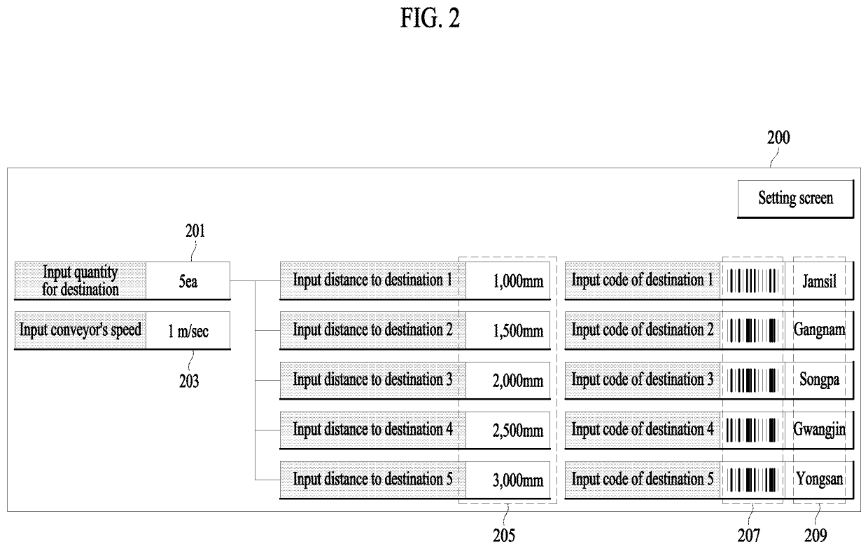

Meanwhile, the electronic device 100 may further include an input module that receives a user input or a display that outputs a user interface related to a user input reception. As an example, the electronic device 100 may output a user interface of FIG. 2 through the display and receive a related user input through the input module. As another example, the electronic device 100 may transmit information related to the user interface of FIG. 2 to an external device through the communication module 190 and receive predetermined user input information from the external device.

FIG. 2 is a diagram illustrating a setting input screen for providing load-related information according to an example embodiment of the present disclosure.

Referring to FIG. 2, the electronic device 100 according to various example embodiments may provide a user interface to set a predetermined condition for providing information related to a load.

For example, the electronic device 100 may provide a setting screen for inputting quantity information 201 of each task area, load transport speed information 203 of a conveyor belt, position information 205 of each task area, and load destination information 207 and 209 corresponding to each task area as information associated with a plurality of task areas (e.g., “destination 1” through “destination 5”) on the conveyor belt.

For example, based on an input of the quantity information 201 of the plurality of task areas, the electronic device 100 may change a number of cells of each input field of the reference numerals 205, 207, and 209 (e.g., the position information 205 of the task areas, the load destination information 207 and 209 corresponding to each of the task areas and provide the changed number of cells. For example, as illustrated in FIG. 2, when input information “Sea” is received in a destination quantity input cell as a quantity of the plurality of task areas, the electronic device 100 may provide a user interface including the distance input field 205 and the load destination input fields 207 and 209 corresponding to each of the “destination 1” through “destination 5” as five task areas.

Meanwhile, in FIG. 2, the distance input field of each of the task areas (e.g., “destination 1” through “destination 5”) may correspond to a field for inputting a distance from a position of at least one sensor (e.g., the code scan sensor 152) to each of the task areas. In an example embodiment, the task areas may be positioned such that respective centers are spaced apart at intervals of about 500 millimeters (mm).

In addition, the electronic device 100 may set load destination information corresponding to each of the task areas on the conveyor belt through the destination input fields 207 and 209 of each load. For example, the electronic device 100 may set a delivery destination of a load handled in a first task area (e.g., “destination 1”) to correspond to “Jamsil” indicated by reference numeral 209. Also, the electronic device 100 may set code information 207 indicating that the delivery destination of the load corresponds to “Jamsil” by mapping the code information 207 to the first task area (e.g., “destination 1”). For example, the electronic device 100 may use at least one sensor (e.g., the code scan sensor 152) to identify code information attached external to the load and identify whether the identified code information corresponds to preset load destination information.

Although the present embodiment is described based on the conveyor belt, a specific form is not limited thereto. Embodiments of the present disclosure may apply in a work environment that a plurality of workers performs a task by selecting loads on a path on which the loads are carried.

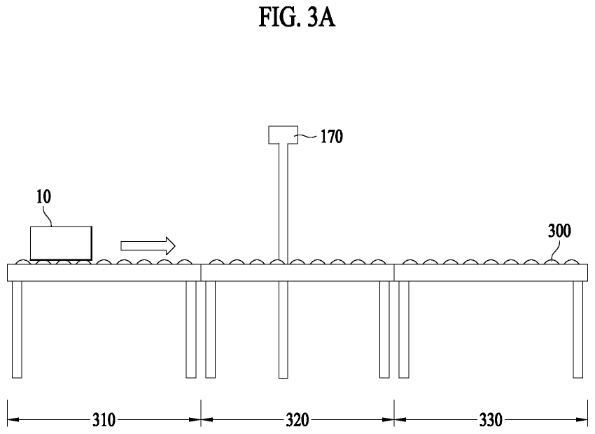

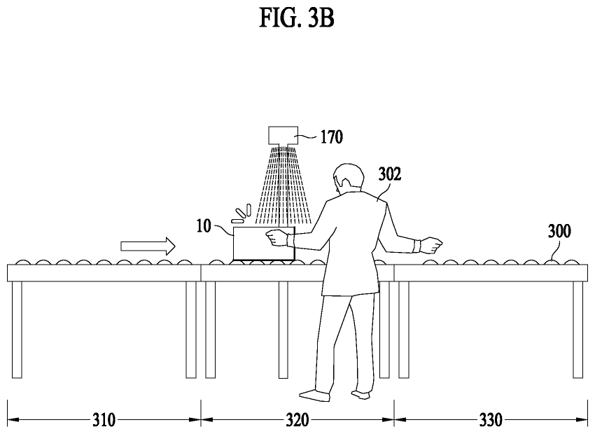

FIGS. 3A and 3B are diagrams illustrating a method of providing load-related information in an electronic device according to an example embodiment of the present disclosure.

Referring to FIGS. 3A and 3B, a specific load 10 carried by the conveyor belt 300 may move in one direction in accordance with the conveyor belt 300 being driven.

The conveyor belt 300 may be divided into a plurality of task areas 310, 320, and 330. The load 10 carried by the conveyor belt 300 may be picked by an operator at one of the task areas 310, 320, and 330 and unloaded from the conveyor belt 300.

In this instance, the plurality of task areas 310, 320, and 330 may be previously set to correspond to delivery destinations of different loads. An operator allotted to each of the task areas may perform a pickup task on a specific load when a delivery destination of a load corresponds to the corresponding task area.

In an example, the electronic device 100 may acquire load delivery-related information (e.g., delivery destination-related information) at a movement start point of the conveyor belt 300 using at least one sensor (e.g., the code scan sensor 152). For example, the electronic device 100 may identify code information attached external to a load using the at least one sensor and identify delivery destination-related information of the load corresponding to the identified code information. In addition, the electronic device 100 may identify a position of a predetermined task area corresponding to the identified the delivery destination-related information of the load.

For example, as a result of the electronic device 100 identifying the delivery destination-related information of the load 10, a destination of the load 10 may correspond to “Gangnam.” In this example, the electronic device 100 may determine a task position in which the load 10 is to be picked up, to be a second task area (e.g., the task area 320). Meanwhile, in the example embodiment, one operator may pick up loads corresponding to a plurality of different destinations, so that the picked loads are collectively transported and delivered to destinations corresponding to the loads.

As illustrated in FIGS. 3A and 3B, the load 10 may be transported by the conveyor belt 300 in a direction from a first task area (e.g., the task area 310) to a third task area (e.g., the task area 330) through the second task area 320. In this case, as shown in FIG. 3A, when the load 10 passes the first task area 310, the electronic device 100 may not provide any information. Also, as shown in FIG. 3B, when the load 10 enters the second task area 320, the electronic device 100 may provide predetermined load access-related information in the second task area 320 so that an operator identifies the load 10 at a point in time in which the load 10 accesses the second task area 320. The operator may identify the load access-related information provided from the electronic device 100 and pick up the load 10 from the conveyor belt 300.

The electronic device 100 may provide at least one of visual information or auditory information as the load access-related information. For example, the electronic device 100 may previously estimate a point in time at which the load 10 accesses the second task area 320 and control the output module 170 to emit light to the second task area 320 or a predetermined notification sound to be output at the estimated point in time.

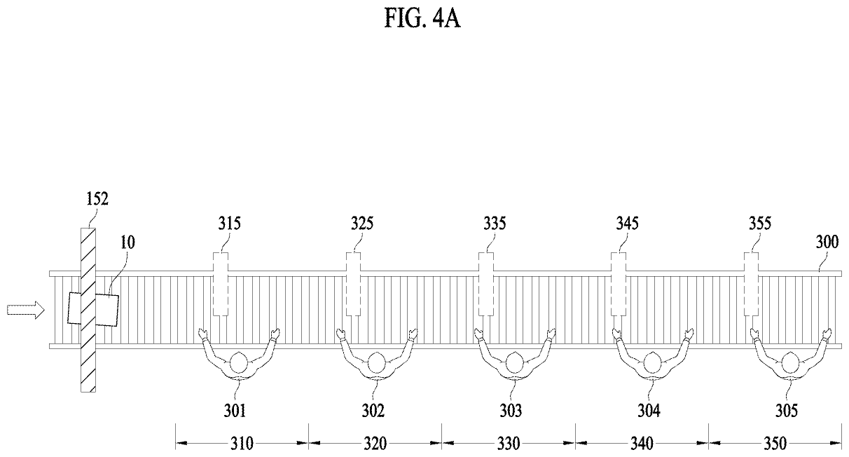

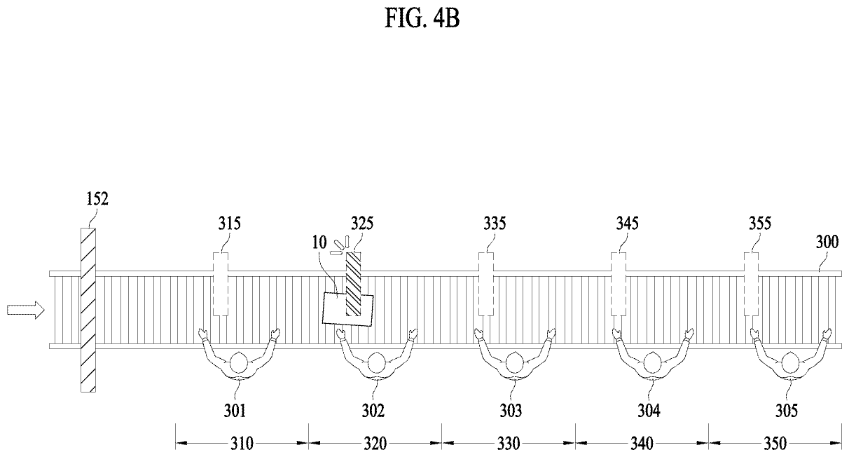

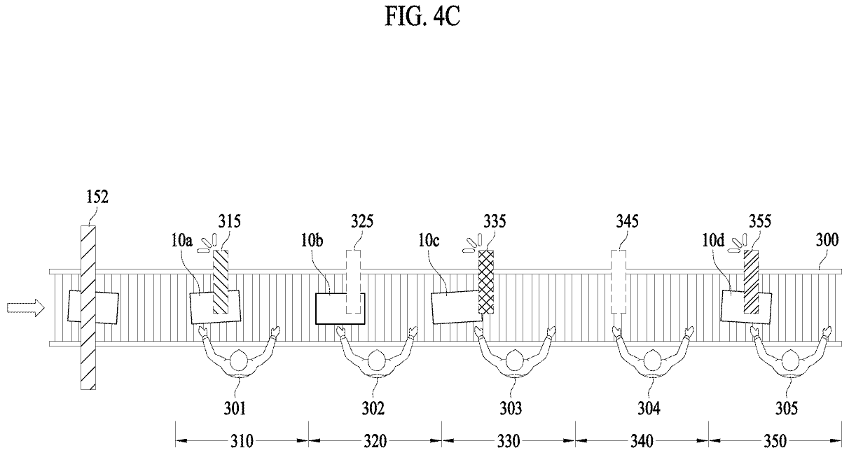

FIGS. 4A through 4C are diagrams illustrating a method of providing load-related information in an electronic device according to various example embodiments of the present disclosure.

Referring to FIGS. 4A through 4C, for each of a plurality of task areas 310, 320, 330, 340, and 350 allocated at preset intervals in a load transport direction of the conveyor belt 300, the electronic device 100 according to various example embodiments may identify a position of a task area corresponding to each load based on a delivery destination of the corresponding load, and provide the corresponding task area with notification information associated with access of the load reaching the task area.

As illustrated in FIGS. 4A through 4C, operators 301, 302, 303, 304, and 305 may be located in the plurality of task areas 310, 320, 330, 340, and 350 to perform a load pickup task. Each of the operators may pick up only a load (for example, a load to be delivered to a delivery destination corresponding to each task area) corresponding to a pickup target assigned to the corresponding operator. For this, each of the operators may identify whether each load is a task target assigned to the corresponding operator.

In an example embodiment, the electronic device 100 may acquire information associated with a delivery destination of a load at a load transport start point of the conveyor belt 300 using at least one sensor (e.g., the code scan sensor 152. Through this, the electronic device 100 may identify a task area in which a task is to be performed on each load. Meanwhile, in some cases, an additional sensor may be provided in another position on the conveyor belt 300. In such cases, the electronic device 100 may monitor a load movement pattern acquired through a plurality of sensors, thereby easily coping with even a situation in which a load transport speed varies based on a work environment.

In addition, information on a load transport speed of a conveyor belt and distance information (or position information of each task area) on a distance from a sensing position of the at least one sensor (e.g., the code scan sensor 152) to each task area may be stored in the memory 130 of the electronic device 100 in advance. The information may correspond to setting information determined based on a user input in advance.

Based on the information stored in the memory 130 in advance, the electronic device 100 may calculate a period of time from a point in time that each load passes the at least one sensor (e.g., the code scan sensor 152) to a point in time that the corresponding load moves to a task area corresponding to a delivery destination. From this, the electronic device 100 may estimate a predicted time that the load accesses a task position.

In FIG. 4A, the load 10 may pass at least one sensor (e.g., the code scan sensor 152) capable of sensing delivery destination-related information of the load 10 on the conveyor belt 300 in accordance with the conveyor belt 300 being driven. For example, the electronic device 100 may identify the load 10 as a target to be handled in the second task area 320 based on the delivery destination information of the load 10. Also, the electronic device 100 may calculate a predicted time to be taken by the load 10 to access the second task area 320 after passing the sensor 152. In FIG. 4B, the load 10 may approach the second task area 320 in accordance with the conveyor belt 300 being driven. Based on a point in time that the load 10 reaches the second task area 320, the electronic device 100 may output information (for example, visual information and/or auditory information) associated with the access of the load at a position 325 corresponding to the second task area 320.

FIG. 4C is a diagram illustrating an operation of the electronic device 100 providing information when a plurality of loads, for example, a first load 10a, a second load 10b, a third load 10c, and a fourth load 10d is sequentially transported in accordance with the conveyor belt 300 being driven.

In FIG. 4C, the electronic device 100 may identify delivery destination-related information of the first load 10d passing the code scan sensor 152. Through this, the electronic device 100 may identify that the delivery destination information of the first load 10d corresponds to a fifth task area (e.g., the task area 350). The electronic device 100 may estimate a predicted access time point at which the first load 10d reaches the fifth task area 350. Also, at the predicted access time point, the electronic device 100 may output information notifying that a load (e.g., the first load 10d) corresponding to a task target accesses a position 355 corresponding to the fifth task area 350. For example, the load access-related notification information may include visual information and/or auditory information. In particular, the visual information may correspond to visual information of first color corresponding to a first frequency band.

Meanwhile, at a point in time of FIG. 4C, that is, a point in time at which the load access-related information is output to the fifth task area 350, the second load 10c to be picked up in the third task area 330 may also access the third task area 330. In this instance, the electronic device 100 may output information indicating that a task target load (e.g., the second load 10c) accesses at a predetermined position 335 corresponding to the third task area 330. The notification information may also include visual information and/or auditory information. In particular, the visual information may correspond to visual information of second color corresponding to a second frequency band.

In addition, at the same point in time, the third load 10a to be handled in the first task area 310 may also access the first task area 310. In this instance, the electronic device 100 may output information notifying that a load (e.g., the third load 10a) to be handled in the first task area 310 accesses, to a predetermined position 315 corresponding to the first task area 310. For example, the notification information may include visual information of third color corresponding to a third frequency band.

According to various example embodiments of the present disclosure, in terms of visual information provided to each of the task areas, the electronic device 100 may provide visual information of colors corresponding to different frequency bands to the task areas. Through this, the electronic device 100 may prevent an operator from misunderstanding that information output in an adjacent task area corresponds to a task target load to be handled by the operator, which may minimize a work error of the operator.

Meanwhile, in FIG. 4C, at a point in time at which load access-related information corresponding to the first task area 310, the third task area 330, and the fifth task area 350 are output, a predetermined load (e.g., the fourth load 10b) may access the second task area 320. For example, the fourth load 10b may correspond to a load to be handled in the fourth task area 340. In this example, even if the fourth load 10b passes the second task area 320, the electronic device 100 may not provide any information. Instead, the electronic device 100 may output notification information to a predetermined position 345 corresponding to the fourth task area 340 at a point in time that the fourth load 10b reaches the fourth task area 340.

According to various example embodiments, when it is determined that the load access-related information is to be output, the electronic device 100 may output the information to a task area of the load within a preset time range. For example, the electronic device 100 may control an output module to output the load access-related information to a task area for a predetermined period of time in which the load is determined as being present in the task area. Also, at a point in time at which it is predicted that the load has been transported to another task area or at a point in time at which another load is possible to access the task area, the electronic device 100 may control an operation of the output module such that the load access-related information is not output continuously.

According to one example embodiment, even when all continuously transported loads are determined as loads to be handled in the same task area, the electronic device 100 may control an operation of the output module to output (e.g., information output ON) access-related information of a first load to the task area, temporarily suspend (e.g., information output OFF) outputting of the information for a preset period of time, and then output (e.g., information output ON) access-related information of a second load. Through this, the operator may clearly distinguish whether each of the output information corresponds to the access-related information of the first load or the access-related information of the second load. For example, when it is identified through or past at least one sensor (e.g., proximity sensor, pressure sensor, temperature sensor, etc.) that the first load has been picked up, the electronic device 100 may suspend outputting the access-related information of the first load. Also, when it is identified through the at least one sensor that the second load accesses the task area, the electronic device 100 may output the access-related information of the second load.

FIGS. 5A through 5C are diagrams illustrating an operation scheme of an output module according to an example embodiment of the present disclosure.

The electronic device 100 according to various example embodiments may output predetermined information through the output module 170 to inform of a position at which a load carried by the conveyor belt 300 is to be picked up. For example, the electronic device 100 may output visual information using the visual information output module 172 or output auditory information using the auditory information output module 174, thereby providing notification information on a task position at which the load is to be picked up.

Referring to FIGS. 5A through 5C, the electronic device 100 according to an example embodiment may include a light output device 510, a driving module 520, and a reflector 530 as the visual information output module 172. The visual information output module 172 of FIGS. 5A through 5C may be provided in a structure for providing visual information to the plurality of task areas 310, 320, and 330 using a single light output device 510.

For example, when it is determined to output visual information to the first task area 310, as illustrated in FIG. 5A, the electronic device 100 (e.g., the processor 110) may adjust an angle of the reflector 530 by controlling the driving module 520 such that light emitted from the light output device 510 is reflected by the reflector 530 and incident onto a position corresponding to the first task area 310.

In addition, when it is determined to output visual information to the second task area 320, as illustrated in FIG. 5B, the electronic device 100 may adjust an angle of the reflector 530 by controlling the driving module 520 such that light output from the light output device 510 travels to correspond to the second task area 320.

Also, when it is determined to output visual information to the third task area 330, the electronic device 100 may adjust a reflection angle of the reflector 530 by controlling the driving module 520 such that light output from the light output device 510 travels to correspond to the third task area 330.

In FIGS. 5A through 5C, when the reflection angle of the reflector 530 is changed in response to a change of a task area to which the visual information is to be provided, the electronic device 100 may change a frequency band of the light output from the light output device 510 such that visual information (e.g., the output light) with a different characteristic is provided to each task area.

Meanwhile, in an example embodiment, the reflector 530 may be formed as a plurality of areas, each being adjustable in angle independently. The light output device 510 may also output light corresponding to the number of areas at the same time. In this case, the plurality of areas may be individually controlled to have different angles. Also, since light sources corresponding to respective area output light individually, the corresponding light may travel to the corresponding task positions even in a case in which so that a plurality of loads reaches corresponding task positions in similar periods of time.

According to various example embodiments, to correspond to two or more task areas, the electronic device 100 may include the visual information output module 172 of the structure described with reference to FIGS. 5A through 5C. For example, when six task areas are present on the conveyor belt 300, the electronic device 100 may provide visual information for first through third task areas through a first visual information output module and provide visual information for fourth through sixth task areas through a second visual information output module.

According to another example embodiment, the electronic device 100 may include a plurality of visual information output modules 172 corresponding to a plurality of task areas. For example, the visual information output modules 172 may be provided on one side of each of the task areas based on the number of works areas and controlled by the electronic device 100 to individually operate based on a situation in which visual information is to be provided in each of the task areas. Meanwhile, like the visual information output modules 172 provided individually to correspond to the task areas, the auditory information output module 174 may be provided for each of the task areas.

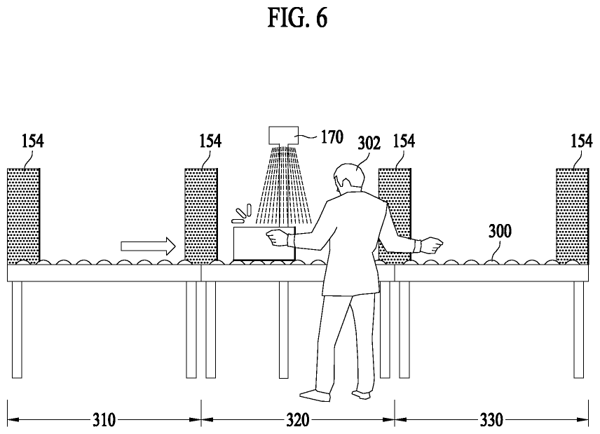

FIG. 6 is a diagram illustrating an operation of a sensor of an electronic device according to an example embodiment of the present disclosure.

Referring to FIG. 6, the electronic device 100 according to an example embodiment may include one or more proximity sensors 154 to sense whether a load carried by the conveyor belt 300 approaches.

The electronic device 100 may identify movement information (or location information) of a load using the one or more proximity sensors 154.

For example, unlike the code scan sensor 152 that identifies delivery-related information of a load, the proximity sensor 154 may not identify information associated with a task area in which each load is to be handled. In this case, the electronic device 100 may use the proximity sensor 154 to identify information on a movement status of a load moving through the conveyor belt 300. Through this, the electronic device 100 may more accurately correct a point in time at which the load is predicted to approach a predetermined task area.

According to an example embodiment, the proximity sensor 154 may be located between the code scan sensor 152 and a predetermined task area. For example, the proximity sensor 154 may be located at a specific point of each of the task areas (e.g., 310, 320, and 330) to scan the movement information of the load more precisely.

According to various example embodiments, the proximity sensors 154 may be placed one by one to correspond to the plurality of task areas, only one proximity sensor 154 may be placed on one conveyor belt 300, or the proximity sensor 154 may not be provided.

The present specification and drawings have been described with respect to the example embodiments of the present disclosure. Although specific terms are used, it is only used in a general sense to easily explain the technical content of the present disclosure and to help the understanding of the invention, and is not intended to limit the scope of the specification. It will be apparent to those skilled in the art that other modifications based on the technical spirit of the present disclosure may be implemented in addition to the embodiments disclosed herein.

The electronic device or terminal in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer-readable recording medium as computer-readable codes or program commands which may be executed by the processor. Here, the computer-readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer-readable recording medium may be dispersed to computer systems connected by a network so that computer-readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The above-described embodiments are merely examples and other embodiments may be implemented within the scope of the following claims.

1. An information providing method of an electronic device, the information providing method comprising:
identifying delivery-related information regarding a load moving along a moving path of the load past at least one sensor;
identifying a task position at which the load is to be picked up from among a plurality of task areas along the moving path based on the delivery-related information;
estimating a point in time at which the load approaches the task position; and
providing information in an output module located at the task position at the estimated point in time, the information indicating to an approach of the load to the task position.

2. The information providing method of claim 1, wherein the providing of the information indicating the approach of the load comprises:
providing at least one of visual information and auditory information indicating the approach of the load in an output module corresponding to the task position.

3. The information providing method of claim 1, wherein the estimating of the point in time at which the load approaches comprises:
estimating a point in time at which the load approaches based on moving speed information of the load moving along the moving path and position information of the plurality of task areas.

4. The information providing method of claim 1, wherein the providing of the information related to the approach of the load comprises:
providing different visual information for each task position based on the delivery-related information regarding the load.

5. The information providing method of claim 4, wherein the providing of the visual information comprises:
emitting, when the load is a task target to be picked up in a first task area, light corresponding to a first frequency band to a task position corresponding to the first task area based on a point in time at which the load approaches the first task area; and
emitting, when the load is a task target to be picked up in a second task area, light corresponding to a second frequency band to a task position corresponding to the second task area based on a point in time at which the load approaches the second task area, the second frequency band being different from the first frequency band.

6. The information providing method of claim 1, wherein the estimating of the point in time at which the load approaches further comprises:
identifying movement information regarding the load using the at least one sensor; and
correcting a predicted access time point of the load for the task position based on the movement information of the load.

7. The information providing method of claim 6, wherein the at least one sensor comprises at least one of a code scan sensor or a proximity sensor.

8. The information providing method of claim 1, wherein the providing of the information the approach of the load comprises:
identifying a frequency band of light corresponding to the task position;
identifying an angle of a reflector corresponding to the task position; and
providing visual information related to the approach of the load to the task position by emitting the light of the identified frequency band to the reflector adjusted to be at the angle.

9. An electronic device comprising:
a processor;
a memory electrically connected to the processor;
an output module; and
at least one sensor,
wherein the processor is set to:
identify delivery-related information regarding a load moving along a moving path of the load using the at least one sensor;
identify a task position at which the load is to be picked up from among a plurality of task areas along the moving path based on the delivery-related information;
estimate a point in time at which the load approaches the task position; and
output information in an output module located at the task position at the estimated point in time, the information indicating an approach of the load to the task position based on the estimated point in time.

10. (canceled)

11. (canceled)

12. The electronic device of claim 9, wherein the processor is set to:
acquire movement information of the load using the at least one sensor; and
correct a predicted approach time point of the load for the task position based on the movement information of the load.

13. The electronic device of claim 9, wherein the output module is located at a plurality of positions corresponding to the plurality of task areas to operate individually.

14. The electronic device of claim 9, wherein the output module comprises a visual information output module and an auditory information output module.

15. The electronic device of claim 9, wherein each of the plurality of task areas is allocated as a task position at which the load is to be picked up based on a designated delivery destination.

16. The electronic device of claim 9, further comprising:
an input module,
wherein the processor is set, by using the input module, to receive a user input related to transport speed information of the load, quantity information of the plurality of task areas, position information of the plurality of task areas, and load destination information corresponding to the plurality of task areas.
